(19) United States
(12) Patent Application Publication
(10) Pub. No.: US 2006/0053047 A1
(43) Pub. Date: Mar. 9, 2006

(54) System and method for selecting targets for sales and marketing campaigns

(76) Inventors: Rita M. Garcia, Reston, VA (US); Michael B. Bryan, Vienna, VA (US); Frank P. Triveri, Reston, VA (US)

Correspondence Address: MORRISON & FOERSTER LLP, 1650 TYSONS BOULEVARD, SUITE 300, MCLEAN, VA, 22102, US

(21) Appl. No.: 10/928,397

(22) Filed: Aug. 30, 2004

(51) Int. Cl. G06Q 30/00

(52) U.S. Cl. 705/14

(57) ABSTRACT

A computer-based system and method for determining targets to contact in a sales or marketing campaign. The present invention provides a storage device that stores at least one consumer preference table containing one or more entries indicating one or more privacy preferences. Each of the entries in the consumer preference table is preferably associated with one or more preference flags. Each preference flag corresponds to a particular preference, such as do not call or do not email. Alternatively, a preference flag may also correspond to a consumer profile demographic. For example, preference flags can correspond to a consumer's age, ethnicity, profession, income, and interests. A user is able to enter via a user device and interface, a prospective consumer target list of prospective consumers. A campaign management module (CMM) then searches among the entries in the consumer preference table for an entry corresponding to a prospective consumer on the prospective consumer target list. Upon completion of the search, the user is presented with a resultant target list of prospective targets and information pertaining to any associated preference flags.

### BACKGROUND OF THE INVENTION

1. Field of Invention

This invention relates to the field of sales and marketing. More specifically, this invention relates to systems and methods for permitting sales and marketing teams to conduct sales and marketing campaigns in accordance with consumer privacy preferences and consumer profiles.

2. Background

Core to the ability to succeed in business is the ability to contact existing and prospective consumers to pass on information about the goods and services provided by the business. Before making such contact, however, a business must take proper steps to ensure that its sales and marketing activities comply with consumer privacy laws imposed by federal, state and local agencies. For example, the Federal Trade Commission maintains a National Do Not Call Registry which lists telephone numbers that, with some exception, telemarketers are prohibited from calling. Equivalent lists are also maintained by several states. In addition to telephone call restrictions, further prohibitions are in place or are being contemplated as regards the sending of e-mails, facsimiles, text messages, and various other forms of marketing media. Other sources of privacy laws and regulations derive from the Telephone Consumer Protection Act (TCPA), Telemarketing Sales Rules (TSR), the Controlling the Assault of Non-Solicited Pornography and Marketing (CAN Spam) Act, federal and state computer crimes and trespass laws, state do-not-call and do-not-contact laws, and the Direct Marketing Association's Privacy Promise. Heavy fines and other sanctions may be imposed upon companies running afoul of the restrictions imposed by these laws. Similar fines and sanctions will likely be associated with future legislation aimed at restricting other forms of media used in connection with commercial sales and marketing endeavors.

In addition to government imposed restrictions, consumers often have strong preferences about solicitation. For example, some consumers have preferences as to the type of solicitations they receive (e.g., new promotions only), the content of the solicitations, the means by which the solicitations are received (e.g., email only, telephone only during specified hours, etc.), and who solicits them (e.g., affinity marketing partners).

In order to ensure that privacy preferences are respected, it is necessary to compare prospective consumer targets against lists reflecting privacy preferences (e.g., the FCC and state do not call lists). This process is sometimes referred to as “scrubbing.” (The term “privacy” contemplates the preferences of both consumers and businesses. For ease of reference and economy, the term “consumer” refers to both consumer and business.) Heretofore, businesses looking to engage in sales and marketing campaigns have had to purchase pre-scrubbed customer lists or send their lists of prospective target consumers to vendors who would scrub the list against various non-solicitation lists, including the Do Not Call registries. In many instances, this process may take two weeks or more. Unfortunately, sales representatives often need to capitalize on opportunities immediately. Thus, any delay could represent lost sales opportunities. On the other hand, failure to respect privacy preferences can result in stiff financial penalties for the soliciting company, the loss of existing consumers, or damage to a business's credibility. Therefore, there is a need to quickly and conveniently determine a prospective target's privacy preferences. Moreover, there is also a need to investigate the circumstances surrounding a complaint that privacy preferences were not respected.

### BRIEF SUMMARY OF THE INVENTION

The present invention is directed to a computer-based system and method for determining targets to contact in a sales or marketing campaign. In particular, the present invention provides a storage device that stores at least one consumer preference table containing one or more entries indicating one or more privacy preferences. The entries in the consumer preference table may include one or more telephone numbers, facsimile numbers, IP addresses, user machine codes, consumer names, email addresses, SMS addresses, two-way text messaging addresses, or other naming conventions used to identify a specific consumer. The consumer preference table may be made up of entries solely corresponding to consumers who show up on one or more do not call lists. In addition to these entries, the consumer preference table may also include entries for consumers not on such lists. Each of the entries in the consumer preference table is preferably associated with one or more preference flags. Each preference flag corresponds to a particular preference, such as do not call or do not email. Alternatively, a preference flag may also correspond to a consumer profile demographic. For example, preference flags can correspond to a consumer's age, ethnicity, profession, income, and interests. Preference flags may also correspond to a consumer's preferences regarding when he or she should be contacted (e.g. time of day, or only in connection with certain types of promotions) and the manner by which such contact should be made (e.g., email only).

In one method, a user is able to enter via a user device and interface, a prospective consumer target list of prospective consumers. Preferably, this is done by entering in prospective consumer target identifiers, such as telephone or facsimile numbers, IP addresses, user machine codes, consumer names, email addresses, SMS addresses, two-way text messaging addresses, or other naming conventions. A campaign management module (CMM), having a controller which receives the prospective consumer target list via a communications interface, and operably in communications with the storage device, then searches among the entries in the consumer preference table for at least one prospective consumer target identifier associated with each of the prospective consumers on the prospective consumer target list.

Upon completion of the search, the user is presented with a resultant target list. In an embodiment of the present invention, the resultant target list contains do not contact information identifying prospective targets for whom contact is prohibited. The resultant target list may also contain information identifying permissible prospective targets to contact. Further, the resultant target list may also contain for each prospective target on the resultant list, a preference message corresponding to the preference flags associated with the prospective target.

In yet another embodiment of the present invention, a user is able to enter via a user device and interface, a prospective consumer target profile list of prospective consumers. A campaign management module, operably in communications with the storage device, then searches for at least one prospective consumer target profile identifier on the prospective consumer target profile list among the entries in a consumer profile table. In an embodiment of the present invention, the consumer target profile identifiers may correspond to a consumer's age, ethnicity, profession, income, and interests. Upon completion of the search, the user is presented with a resultant target list of prospective targets who match at least one of the prospective consumer target profile identifiers on the prospective consumer target profile list.

In each of the embodiments above, once the resultant list is determined, the user may contact the users via any communications means or the users may be automatically contacted and presented with sales and marketing information in any possible content form.

Further features of the present invention, as well as the structure and operation of various embodiments of the present invention are described in detail below with reference to the accompanying drawings.

### BRIEF DESCRIPTION OF THE DRAWINGS

The accompanying drawings, which are incorporated herein and form part of the specification, illustrate the present invention and together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 is a high level block diagram of a sales and marketing campaign management system according to an embodiment of the present invention.

FIG. 2 is a block diagram of a general purpose computer system embodiment of the present invention.

FIG. 3 is an illustration depicting a sales and marketing campaign management system using a client server architecture according to an embodiment of the present invention.

FIG. 4 is an illustration depicting a sales and marketing campaign management system using a distributed network architecture according to an embodiment of the present invention.

FIG. 5 is an illustration depicting further features of a sales and marketing campaign management system according to an embodiment of the present invention.

FIG. 6 is an illustration depicting a method for loading consumer preference data into the consumer preference table according to an embodiment of the present invention.

FIGS. 7 and 8 are illustrations depicting example consumer preference tables according to an embodiment of the present invention.

FIG. 9 is a flow chart diagram of a method for determining consumer targets in a sales and marketing campaign according to an embodiment of the present invention.

FIGS. 10, 11, 12A and 12B are sample screen shots presented on a display associated with a user interface device according to an embodiment of the present invention.

FIG. 13 is a flow chart diagram of a method for determining consumer targets in a sales and marketing campaign using a wireless device as the user interface device according to an embodiment of the present invention.

FIGS. 14A-14D are illustrations depicting screen shots presented on a display of a wireless user device according to an embodiment of the present invention.

FIG. 15 is a flow chart diagram of a method for determining consumer targets in a sales and marketing campaign using email addresses according to an embodiment of the present invention.

FIGS. 16-18 are illustrations depicting screen shots presented on a display according to an embodiment of the present invention.

FIG. 19 is an illustration depicting a sample consumer preference table containing flags indicating sample demographic information according to an embodiment of the present invention.

### DETAILED DESCRIPTION OF THE INVENTION

1. Overview of the Invention

The present invention is directed to a system, method, and computer program product for enabling users to perform rapid database searches to determine if prospective consumer targets appear on one or more consumer preference lists. The invention is particularly well suited and useful for quickly identifying prospective target consumers who do not wish to receive telephone calls, emails, facsimiles, text messages, and other forms of media used to contact prospective consumers during sales and marketing campaigns. The invention is also very useful for conducting targeted sales and marketing campaigns based on reaching a certain demographic profile of the general public. The invention is further useful for identifying the particular types of sales and marketing information a prospective consumer wishes to receive and the format in which he or she would like to receive such information. Still further, the present invention allows a user to generate and forward to permitted target consumer groups one or more electronic messages in compliance with federal and state privacy laws.

The present invention searches for the contact information associated with a prospective consumer target across a number of preference lists in order to identify corresponding entries on the preference lists. Preferably, the present invention achieves this functionality by allowing a user to enter via a user interface one or more prospective consumer identifiers (such as name, ID, phone number, email address, IP addresses, machine code, etc.) for one or more target consumers. The invention then uses the prospective consumer target identifiers for each of the target consumers to search for matching consumer preference information maintained in one or more preference tables and produces an interactive display or printout of the results to the user. From the display or printout of the resultant target list, the user is able to visually identify the privacy preferences associated with each of the one or more target consumers. If desired, the user may then use the resultant target list to contact permissible targets using voice, email, print media or television advertisements through any conventional communications means including wired or wireless telephone systems, cable or dBS distribution systems, amongst others well known in the art. Alternatively, permissible and scrubbed targets from the resultant target list (e.g., targets that do not appear on any Do Not Call lists or for which there is an established business relationship) can be contacted automatically via any of the aforementioned means including automated voice or email, as examples, immediately upon completion of the process or some predetermined time thereafter. In this latter embodiment, user interaction is not required.

In another embodiment of the invention, a sales or marketing agent will actually be blocked from contacting a target consumer from their phone or computer, for example, if the resultant target list from the search identifies the target consumer as one on the do not call lists or who otherwise does not want to be contacted.

The present invention maintains archival data related to when preference data became available and when preference data was deleted. Further, the system and method of the present invention can store archival data in databases, for example, relating to resultant advertising and marketing campaigns based on search results including when a “scrubbed” person or household was contacted and if and when the contacted person or household purchased the marketed product or service. In this manner, the business can maintain the results of their marketing and sales campaigns. The system is further able to verify whether and when prospective consumer target data was scrubbed against the consumer preference table to determine if contact with a target consumer was authorized.

2. Exemplary Structural Environment

Referring initially to FIG. 1, a sales and marketing campaign management system 100 will now be described according to embodiments of the present invention. The invention, however, is not limited to these example embodiments. Other implementations of the sales and marketing campaign management system 100 will be apparent to persons skilled in the relevant arts based at least in part on the teachings contained herein.

2.1 Sales and Marketing Campaign Management System

FIG. 1 is a high level block diagram of the sales and marketing campaign management system 100. The system 100 includes a preferences database 105. The preferences database contains one or more consumer preference tables. The consumer preference tables contain entries indicating a user's preferences. Such entries may include information identifying consumers or consumer households which may include one or more of the following: names, home addresses, wireline and mobile telephone numbers, facsimile numbers, email addresses, IP addresses, SMS addresses, text-messaging addresses, other naming conventions, or codes indicating the same. Further, the consumer preference tables may include information relating to a consumer's preferences. For example, flags or codes may be used to identify if a consumer appears on any of the federal, state or other Do Not Call lists, which indicate that a consumer or consumer household does not want to be contacted. Other lists which may be flagged in the consumer preference table include a phone or wireless operator's own consumer Do Not Call or other such list. Consumer preferences may include codes representative of a consumer's desires to receive only certain types of content via only certain delivery means at certain times of the day, for example. Further, the consumer preference table may contain preference flags corresponding to consumer profile data including demographic data, interests, operator service plan history, amongst other things.

Sales and marketing campaign management system 100 also includes a user interface 115. User interface 115 provides interaction between a user and sales and marketing campaign management system 100. In particular, user interface 115 allows a user to access the functionality of sales and marketing campaign management module 110. Further, the user interface 115 allows the user to enter information identifying prospective consumer targets. A user may desire to enter in phone numbers or email addresses as prospective consumer target identifiers, for example.

The prospective consumer target identifiers are preferably received at the campaign management module 110. Sales and marketing campaign management module 110 may contain processor controlled computer software routines used in conducting preference searches of the consumer preferences table in the preferences database 105.

As will be described further below, users may access and traverse the functions provided by the sales and marketing campaign management module 110 in any number of ways via interaction with menus, voice recognition or clicking on icons or depressing keys provided by the user interface 105. Other ways of accessing sales and marketing campaign management module 110 will be apparent to persons skilled in the relevant arts based at least on the teachings contained herein.

2.2 Computer System Embodiment

In one embodiment, the components of the sales and marketing campaign management system 100, shown in FIG. 1, can be implemented in whole or in part using a conventional computer system 200, the components of which are shown in FIG. 2. The conventional computer system 200 could a conventional personal computer, a personal data assistant, wireless phone, mobile device, cable or satellite set top box or electronic tablet or combinations of any of the above operably in communications with one another.

The computer system 200 includes one or more processors 202 connected to a communication bus 204. The computer system 200 also includes a main memory 206. Main memory 206 may be random access memory (RAM), read only memory (ROM), EPROM, and/or EEPROM. Computer system 200 further includes secondary memory 208. Secondary memory 208 includes, for example, hard disk drive 210 and/or removable storage drive 212. Removable storage drive 212 could be, for example, a floppy disk drive, a magnetic tape drive, a compact disk drive, a program cartridge and cartridge interface, or a removable memory chip. Removable storage drive 212 reads from and writes to a removable storage unit 214. Removable storage unit 214, also called a program storage device or computer program product, represents a floppy disk, magnetic tape, compact disk, or other data storage device.

Computer programs or computer control logic are stored in main memory 206 and/or secondary memory 208. Thus, for example, the campaign management module (CMM) routines may be stored in either main memory 206 and/or the secondary memory 208. Preferably, processor 202 of other controller in the general purpose computer may operate as the CMM controller. Further, the preferences database 105, which contains the consumer preference table, could be implemented in main memory 206 or secondary memory 208.

Computer system 200 further includes a communications interface 216. Communications interface 216 enables the computer system 200 to send and receive software and data to/from external devices 218. Information may be communicated from the communications interface 216 over any transmission known in the art including wireless or wireline networks, cable distribution back channels, online information networks, Internet, Intranet or any other transmission means known in the art. Examples of communications interface 216 include a modem, a network interface, and a communications port.

As discussed above, the sales and marketing campaign management system 100 may be centralized in a single computer system 200 with the campaign management module containing processor 202 controlled programs residing in memory 206, 208 or 218.

Referring again to FIG. 2, the user interface 220 may be a keyboard, remote controller device, personal data assistant, cell phone punch pad, a microphone and voice recognition system, or any other conventional means to enter data. The user interface 110 may connect directly to the general purpose computer 200 of to an external device 218, as shown in FIG. 2.

In other embodiments, the sales and marketing campaign management system 100 is distributed among multiple computer networked systems, examples of which are shown in FIGS. 3 and 4, as explained in further detail below. The degree of centralization or distribution is implementation and/or application dependent.

For example, consider FIG. 3 which illustrates an embodiment of the present invention. In this embodiment, campaign management module (CMM) 110 containing a controller and preferences database 105 could reside in host computer 320. A user accesses sales and marketing management module 110 over communications network 315 using user interface 105, depicted in the example as a general purpose computer 305. As with FIG. 2, the user interface 220 in FIG. 3 may be the computer 305 or partially or wholly implemented via keyboard, remote controller device, personal data assistant, cell phone punch pad, a microphone and voice recognition system, or any other conventional means to enter data. Of course, the user interface 105 may alternatively be a personal data assistant, wireless phone, mobile device, cable or satellite set top box or electronic tablet in this embodiment acting alone or in combination with the general purpose computer 305. Communications network 315 may be wireless or wireline networks, mobile networks, cable or satellite distribution back channels, online information networks, Internet, Intranet or any other transmission means known in the art.

Alternatively, the routines and functions of the sales and marketing campaign management module 110 could be implemented solely within the terminal 305 or shared between the terminal 305 and the host computer 320 in a client/server relationship. For example, the user may enter prospective consumer target identifiers via user interface into the computer terminal 305. The campaign management module (CMM) 110 formats and sends the consumer target identifiers and a request via communications network 315 to the host computer 320. At the host computer 320, the host computer controller component of the campaign management module 110 receives and processes the request from the terminal 305. Under processor control, the module 110 searches the preferences database 105 stored in either local or remote storage according to the processes described in more detail below in reference to FIGS. 5 through 9 to obtain the resultant target list. The resultant target list is preferably communicated back to the terminal 305 and displayed or printed out to the user.

Referring to FIG. 4, in yet another embodiment, user interface 115 could reside in personal computer 410, laptop 418, wireless phone 412, car phone 414 or any other conventional device. Communications network 415 may be wireless or wireline networks, mobile networks, cable or satellite distribution back channels, online information networks, Internet, Intranet or any other transmission means known in the art. Using communications network 415, personal computer 408 or any other of the user interface devices could then access campaign management module 110, preferably residing on computer 420, and the computer 408 may forward the requests and prospective consumer target identifiers via web browser if the communications network is the Internet or Intranet, for example. In this regard, computer 420 may be configured to operate as a web server. The campaign management system 110 controller may then direct searches of the preferences database 105 residing on host computer 425.

Referring to FIG. 5, a number of preference data sources 505 maintain and provide preference lists either identifying individuals who do not wish to be contacted or who have certain preferences as to when and how they are contacted in connection with sales and marketing campaigns. Preference data sources 505 may be the Federal Trade Commission, State Attorney General Offices, marketing associations, and telemarketing companies, as examples. Preference data sources 505 may also be businesses which provide their own consumer lists to be searched against the preference data compiled by other preference data sources 505. The Local Exchange Resource Guide (LERG) 518 provides a directory which identifies whether a given area code and prefix is associated with a wireless telephone number. Similarly, Wireless Number Port 520 maintains a directory of wireless telephone numbers being ported from one service provider to another. Thus, LERG 518 and WNP 520 may both also be used a data source. Identifying wireless numbers is important since direct marketing to wireless telephone numbers using an autodialer is restricted. Further, number portability may allow a wireline telephone number to become a wireless number. In this case, it may be necessary for the FCC to also serve as a data source. The information provided by preference data sources 505, 518, and 520 may include the name, telephone number, email address, IP address, facsimile number, and address of a person or business. The information may also relate to such demographics as household income, buying habits, gender, ethnicity, education level, and personal interests.

The information provided by preference data sources 505 may include the name, telephone number, email address, SMS address, text-messaging address, IP address, facsimile number, and address of, or naming convention for, a person or business. The information may also relate to such demographics as household income, buying habits, gender, ethnicity, education level, and personal interests, for example.

Consumers often have established business relationships (EBR) with several companies and may convey their preferences directly to such businesses. For example, many businesses provide websites which consumers may access from an external device. While interacting with the website, a consumer will often register his or her personal contact information, interests and specify the type of promotional materials of interest. Of course, consumers sometimes request that they not receive any promotional materials at all. In one embodiment of the present invention, such preferences are accumulated in an internal registry preferences database 512.

As a consequence of the EBR the consumer has with a given business, the consumer may have occasion to deal with the business' consumer support center. During these encounters, consumers may also convey their privacy preferences. Thus, in an embodiment of the present invention, sales and marketing campaign management system 100 is also comprised of a consumer care preferences database 516. Still further, a consumer may indicate after being contacted by a business that she does not wish to be contacted again in the future. In accordance with embodiments of the present invention, such preferences may also be provided to sales and marketing campaign management system 100.

The preferences database 105 serves as a central repository of the preference data collected from the various preference data sources 505, internal registry preferences database 512, and consumer care preferences database 516. Preferably, the accumulated consumer preferences are formatted and stored as tables in fields in databases commonly known in the art.

The invention is not limited to these example embodiments. Other implementations of the sales and marketing campaign management system 100 will be apparent to persons skilled in the relevant arts based at least in part on the teachings contained herein.

3.0 Exemplary Operation of the Invention

3.1 Preference Data Load Method

FIG. 6 illustrates one manner in which consumer preference tables are created in the preferences database 105 with preference data from preference data sources 505.

In the first step 602, preference data is obtained from one or more preference data sources 505 (e.g., preference data from the DO NOT CALL list maintained by the Federal Trade Commission.) The preference data files are automatically downloaded or requested from the preference data sources 505 to one or more computers associated with campaign management module 110. The consumer preference data can be stored in a program storage device disclosed in FIGS. 2 through 4, for example. Preferably, a script program examines the timestamp associated with each received preference data file to identify new preference data files obtained since the last system update. Once identified, the new preference data files are moved to a pre-staging area.

In step 604, the preference data is further processed and formatted in the pre-staging area. For example, the data may be checked to confirm that all the expected data was received and that it arrived in the proper format. Some of the extraneous information is removed from the original preference lists. Further, the preference data file names are associated with a date reference indicating when the preference data files were uploaded. The updated preference data files are then moved from the pre-staging area into a staging area.

Consumer preferences may change periodically. For example, a consumer registered on a do not call list may be removed after a specified period. Still further, a consumer may decide at some point that he or she only wants to be contacted via electronic mail. The occurrence of each of these events may be evidenced by an entry in the preference data file or in the case of removal, the absence of an entry in the preference data file. For this reason, it is necessary to compare the updated preference data files to the information presently stored to identify any changes. Staging temp-tables reflect the information currently stored in the consumer preference tables.

In step 606, the updated preference data files are compared to staging temp-tables. Any differences identified are recorded in archive tables (step 608). Archive tables may then be accessed whenever it is necessary to determine when a preference was added or removed from the consumer preference tables. Data is then moved from the staging area table to a staging temp-table and the staging area table is also truncated. In addition, a temporary operational data store table is created.

Referring to FIG. 7, the preference data is stored temporarily in a temporary operational data store table 705. Each line entry within the table 705 corresponds to a specific consumer identified, for example, by a telephone number. Each line entry could alternatively refer to an email address, IP address, name or other contact information uniquely associated with a particular consumer.

In one embodiment of the present invention, the consumer preference tables may merely consist of entries that disclose email addresses or phone numbers of consumers that either do or do not appear on one or more do not call lists. In other embodiments, the entries may be more universal and indicate both consumers on such lists and those not on such lists. Again, in any of these embodiments any indicator of a consumer is within the scope of the invention including name, address, email address, phone number, social security number, IP address or any other such descriptor.

One way to indicate consumer preferences in the consumer preference table is to include one or more preference flags 705 corresponding to a particular preference. For any given consumer indicator entry (e.g., telephone number, email address, etc.), a preference flag will be set to identify whether the target appears on the FTC lists, a particular states lists, an in-house, or internal list, etc. Each entry may also have an associated reason code 710. Reason code 710 identifies the basis for that consumer appearing on such a list. The information maintained in the consumer preference table is key to conducting successful sales and marketing campaigns. First, it ensures that contacts are not initiated with consumers who have registered their preference not to be contacted. Second, despite a consumer's registered preference not to be contacted, contact may still be initiated if an existing business relationship exists. The information contained in the consumer preference table may be used to quickly identify such existing business relationships.

Returning again to FIG. 6, once the temporary operation data store table is created, in the next step 608, data from the temp operational data store table is loaded into an active operational data store table, as shown in FIG. 8. The active operational data store table is then checked for any records tagged for deletion (i.e. all flags are off or reason code is NULL). Once completed, the active operational data store table is ready for querying and the temporary operational data store table may be truncated.

3.2 Operation

The methods of operation of the present invention will now be further described with reference to FIGS. 10-12 and flowchart 900, shown in FIG. 9.

Flowchart 900 illustrates one manner in which a user interacts with sales and marketing campaign management system 100 via user interface 115 to search the preference tables using prospective consumer target identifiers to obtain a resultant target list.

Flowchart 900 begins with step 902. In step 902, the user invokes sales and marketing campaign management system 100 in any well known manner, such as selecting an icon associated with the sales and marketing campaign management system 100. Step 902 may also include steps for authenticating the user and verifying authorized access to system 100.

In step 904, sales and marketing campaign management system 100 displays on a portion of a user interface 115, a main screen 1005. See, for example, FIG. 10. Main screen 1005 includes one or more preference query entry windows 1015 to allow a user to enter one or more prospective consumer target identifiers for a prospective consumer that the user would like to contact or have contacted automatically. In the present example, the user is prompted for a telephone number as the prospective consumer target identifier. In other embodiments, however, the user could be prompted to enter any other type of prospective consumer target identifier, such as a person's name, email address, IP address, home address, facsimile number, social security number, or any type of code.

Main screen 1005 further includes a number of command windows 1010. Command windows 1010 enable the user to specify how the resultant target list from the search should be presented. Command windows 1010 also include a search execution indicator 1020. Search execution indicator 1020 allows a user to submit her search to the sales and marketing campaign management module 110 for execution. The manner of generating screens such as main screen 1005 will be apparent to persons skilled in the relevant arts.

Referring again to FIG. 9, step 904, the user submits the prospective consumer target identifiers. In the present example, the user is able to enter between 1 and x prospective consumer target identifiers for searching the consumer preference tables.

In step 906, the user optionally is prompted to wait while system 100 validates that the prospective consumer target identifiers were entered in the correct format. (step 910).

Once the input is validated and confirmed (step 914), the prospective consumer target identifiers are prepared for entry into the campaign management module 110. Thus, in step 916, any extraneous characters, such as dashes or spaces are removed. The campaign management module 110 (CCM) consisting of a controller that next searches the preference table in the preferences database 105 for entries that match the search criteria (Step 918). The present invention may use any type of searching algorithm conventionally known in the art including table lookup.

One way that the preferences database 105 may be searched is through conventional linkage of a Web site to the preferences database 105. In this example, the preferences database 105 may be a simple database or complex database such as an Oracle SQL database. In this manner, the user interface screen 1005 may actually be a Web page which includes the form as shown in FIG. 10 to enter the prospective consumer target identifiers. The Common Gateway Interface can bridge together the Web site and the preferences database 105.

In step 918, sales and campaign management module 110 searches the consumer preference entries contained in preferences database 105 to identify any entries which correspond to the prospective consumer target identifiers entered by the user in step 904.

Upon the completion of step 918, processing continues with step 922. In step 922, any corresponding consumer preference entries identified in step 918 (i.e., those that matched the prospective consumer target identifiers submitted by the user) may be saved temporarily along with their associated reason code and preference flags in main memory 206. Alternatively, the corresponding consumer preference entries could be saved in secondary memory 208 or removable storage unit 214. If information pertaining to multiple target contacts was submitted in step 904, then control returns to step 918.

If there are no additional prospective consumer target identifiers to be searched, then processing continues with step 924. In step 924, the prospective consumer target identifiers and their associated reason code and preference flags are used to produce a resultant target list.

In step 926, campaign management module 110 generates a search results screen. In one embodiment, a preference search results screen 1100 (FIG. 11) displays the resultant target list in an HTML format. In yet another embodiment, a preference search results screen 1200A (FIG. 12) displays the resultant target list in a spreadsheet format. Accordingly, preference search results screen 1200A includes a plurality of preference display cells arranged in columns and rows. In yet another embodiment, a preference search results screen 1200B (FIG. 12B) is displayed in a text file format. Accordingly, each line corresponds to a separate target.

The sales and marketing campaign management system 100 may include a preference message. Referring again to FIG. 11, preference messages indicate for example, whether it is okay to call, if a number is valid, or if it is not okay to call and the reasons why. Referring to a fist entry in screen 1100 in FIG. 11, the number shown in (1) should not be contacted due to its being identified as being on the FTC, Virginia, internal corporate and DMA Do Not Call lists. By providing such preference messages, the present invention provides the user with the ability to quickly identify target contacts that can and cannot be contacted. One skilled in the relevant arts will recognize other ways of emphasizing the comparative results without departing from the scope and spirit of the present invention.

The user may want to automatically initiate a call to the prospective targets identified on the resultant target list whose preference message indicates that it is okay to call. Thus in an embodiment, campaign management module 110 can be connected to an automatic telephone dialer, as conventionally known in the art. Campaign management module 110 can then provide the automatic telephone dialer with the prospective consumer target identifiers corresponding to the prospective targets on the resultant target list that can be contacted. The automatic telephone dialer can then call these prospective consumer targets without further intervention of the user.

3.3 Exemplary Wireless Embodiment

Many sales and marketing representatives spend the majority of their time in the field visiting prospective consumers. For this reason, the present invention is further able to be accessed from mobile devices, such as wireless handsets, wireless computers, and personal data assistants. In this way, the sales and marketing representatives can identify the privacy preferences of prospective consumers wherever and whenever the need arises. A method for using the present invention with a mobile communications device will now be described with reference to the steps shown in FIG. 13 and the exemplary external device shown in FIG. 14.

In a first step 1302, a user invokes on a mobile communications device 1400 (FIG. 14A), sales and marketing campaign management system 100 in any well known manner, such as selecting an icon or depressing a key on the device 1400 keypad associated with the sales and marketing campaign management system 100. In an embodiment, step 1302 may also include steps for authenticating the user and verifying authorized access to system 100.

In step 1304, sales and marketing campaign management system 100 displays on mobile communications device 1400, a preference query entry window 1405 (FIG. 14B). Preference query entry window 1405 allows a user to enter one or more prospective consumer target identifiers for prospective consumers that the user would like to contact. In the present example, the user is prompted to enter a telephone number as the prospective consumer target identifier. However, in other embodiments, the user could be prompted to enter any other type of prospective consumer target identifier, such as a name, telephone number, email address, IP address, facsimile number, mailing address of a person or business, and other naming conventions.

In step 1304, the user submits the prospective consumer target identifiers to be searched. Step 1304 is completed upon the user's selection of the search execution indicator 1410.

In step 1312, the user is prompted to wait while system 100 validates that the prospective consumer target identifiers were entered in the correct format.

Once the input is validated and confirmed, the prospective consumer target identifiers are prepared for entry into the campaign management module 110. Thus, in step 1314, any extraneous characters, such as dashes, parenthesis, or spaces are removed. The sales and marketing campaign management module 110 consisting of a controller next searches the preference tables in the preferences database 105 for the entries that match the search criteria (Step 1316).

In step 1316, sales and marketing campaign management system 100 searches the consumer preference entries contained in preferences database 105 to identify any entries which correspond to the prospective consumer target identifiers entered by the user in step 1304.

In step 1318, any corresponding target contact information identified in step 1316 (i.e., those that matched the prospective consumer target identifiers submitted by the user) may be temporarily saved along with their associated reason code and preference flags in main memory 206. In other embodiments, the corresponding target contact information could be saved in secondary memory 208 or removable storage unit 214, for example. If information pertaining to multiple target contacts was submitted in step 1304, then control returns to step 1316 or alternatively all searches may be done in parallel.

If there are no additional prospective consumer target identifiers to be searched, then processing continues with step 1320.

In step 1320, the prospective consumer target identifiers and their associated reason code and preference flags are used to produce a resultant target list.

In step 1322, campaign management module 110 generates a preference search results screen 1412 (FIG. 14C).

In an embodiment, campaign management module 110 includes a preference message with each prospective consumer target on the resultant target list to identify the preference data contained in preferences database 105 for that particular target. Where the preference message indicates that it is okay to contact the target 1412C (FIG. 14C), then the user may be presented with the option of placing a call to the target contact. Similarly, if it is not okay to contact the target, then the preference message will indicate the reasons why 1412D (FIG. 14D). Assuming a call is placed and the target requests to be placed on the caller's do-not-call list, the caller may facilitate the honoring of that preference via a consumer preference update screen.

3.4 Exemplary Email Embodiment

The operation of further embodiments of the present invention will now be further described with reference to FIGS. 16-18 and flowchart 1500 (FIG. 15).

Flowchart 1500 illustrates one manner in which a user interacts with sales and marketing campaign management system 100 via user interface 115 to search the preference tables using email target contact information to obtain a resultant target list.

Flowchart 1500 begins with step 1502. In step 1502, the user invokes sales and marketing campaign management system 100 in any well known manner, such as selecting an icon associated with the sales and marketing campaign management system 100. In an embodiment, step 1502 may also include steps for authenticating the user and verifying authorized access to system 100.

In step 1504, sales and marketing campaign management system 100 displays on a portion of a user interface, a main screen 1605. See, for example, FIG. 16. Main screen 1605 includes one or more preference search entry windows 1615 to allow a user to enter one or more prospective consumer target identifiers for a prospective consumer that the user would like to contact. In the present example, the user is prompted for an email address.

Main screen 1605 further includes a number of command windows 1610. Command windows 1610 enable the user to specify how the resultant target list from the search should be presented. Command windows 1610 also include a search execution indicator 1620. Search execution indicator 1620 allows a user to submit her search to sales and marketing campaign management module 110 for execution. The manner of generating main screen 1605 will be apparent to persons skilled in the relevant arts.

Referring again to FIG. 15, in step 1504, the user submits the prospective consumer target identifiers to be searched. In the present example, the user is able to enter between 1 and X email addresses as prospective consumer target identifiers to be searched. Step 1504 is completed upon the user's selection of the search execution indicator 1620.

In step 1506, the user is optionally prompted to wait while system 100 validates that the prospective consumer target identifiers were entered in the correct format. (step 1510).

Once the input is validated and confirmed (step 1514) the prospective consumer target identifiers are prepared for entry into the campaign management module 110 for execution of the preference search. Thus, in step 1516, any extraneous characters, such as nick names or quotation marks which proceed the email address (e.g. “JD” JohnDoe@nextel.com) are removed. Campaign management module 110 controller next searches preferences database 105 for entries that match the search criteria (Step 1518).

In step 1518, sales and marketing campaign management module 110 searches the consumer preference entries contained in preferences database 105 to identify any email address entries which correspond to the prospective consumer target identifiers entered by the user in step 1504.

Upon the completion of step 1518, processing continues with step 1522. In step 1522, any corresponding target contact information identified in step 1518 (i.e., those email addresses that matched the target contact information submitted by the user) may be temporarily saved along with its associated reason code and preference flags. In one embodiment, the corresponding target contact information is saved temporarily in main memory 206. In other embodiments, the corresponding target contact information could be saved in secondary memory 208 or removable storage unit 214, for example. If information pertaining to multiple target contacts was submitted in step 1504, then control returns to step 1518.

If there are no additional target contacts to be searched, then processing continues with step 1524. If additional targets are to be searched, such searches may be done serially or in parallel according to search methodologies known in the art.

In step 1524, the prospective consumer target identifiers and their associated reason code and preference flags are used to produce a resultant target list.

In step 1526, sales and marketing campaign management module 110 generates a preference search results screen 1700 (FIG. 17). In yet another embodiment, preference search results screen 1700 is displayed in a spreadsheet format. In yet another embodiment, preference search results screen 1700 is displayed in a text file format.

In one embodiment, sales and marketing campaign management module 110 includes a preference message with each prospective consumer target to identify the preference data contained in preferences database 105 for that particular target. Referring still to FIG. 17, preference messages indicate for example, whether it is okay to email, if an email address is valid, or if it is not okay to email. By providing such preference messages, the present invention provides the user with the ability to quickly identify target contacts that can and cannot be contacted.

Returning again to FIG. 15, where the preference message indicates that it is not okay to contact the target (step 1528), then processing ends at step 1530. However, if the preference message indicates that it is ok to email at least one of the target contacts appearing on the resultant target list, then in step 1532, the user may be presented with the option of composing an email. Further details of step 1532 will be provided with reference to FIG. 18.

There are several federal and state laws which specify that certain disclosures be made when sending commercial email. Further, instructions must be provided for the recipient to “opt out” of receiving future commercial emails. Therefore, to be sure that all sales and marketing emails comply with the relevant laws, in an embodiment of the present invention, a commercial email template 1805 (FIG. 18) is provided. The disclosures and user options provided with commercial email template 1805 may be modified as required to comply with federal and state laws.

The user may want to automatically send an email to the prospective targets identified on the resultant target list whose preference message indicates that it is okay to email without having to first look at the preference search results. Thus in an embodiment, campaign management module 110 can be connected to an automatic email generation system. Campaign management module 110 can then provide the email generation system with the prospective consumer target identifiers corresponding to the prospective targets on the resultant target list that can be emailed. The automatic email generation system can then email these prospective consumer targets without further intervention of the user.

4.0 Subscription Based Services

In accordance with an embodiment of the present invention, sales and marketing campaign management system 100 may be offered to users on a subscription basis. In exchange for a subscription fee, a subscriber of system 100 would be authorized to access sales and marketing campaign management system 100 for the purpose of searching the subscriber's prospective consumer target identifiers among consumer preference entries contained in preferences database 105. In an embodiment of the present invention, the subscriber is further able to submit preference data obtained by the subscriber to sales and marketing campaign management system 100 to be saved, for example, in preferences database 105.

5.0 Targeted Advertising and Marketing Services

The most successful advertising and marketing campaigns are those that are directed to the prospective consumers most likely to be interested in the product or services being offered. In this regard, access to demographic information about persons or businesses and their buying habits is extremely valuable. Therefore, in an embodiment of the present invention, preference data sources 505 may provide sales and marketing campaign management system 100 with demographic information. For businesses, demographic information might include, for example, yearly revenue and sales data. For individuals, demographic information might include, for example, buying habits, household income, gender, ethnicity, education level, and personal interests.

Demographic information may be saved in preferences database 105. In an embodiment, demographic information is saved in a consumer preference table 1905 (FIG. 19). In an embodiment of the present invention, each line in the table corresponds to a particular prospective consumer target identifier, for example name, telephone number, email address, IP address, facsimile number, and address of a person or business. Each target can also have one or more preference flags 1910 corresponding to a particular demographic and may or may not include do not call and other consumer preference information as described herein. For any given prospective consumer target identifier, a preference flag will be set to identify the demographic and any consumer preferences associated with the target.

As described above, a user may submit a preference search for a target using the target's name, email address, facsimile number or other identifying information. Alternatively, the user may submit a preference search for a target using any of the one or more preference flags corresponding to a particular demographic or consumer preference. For example, the user may execute a search for targets that are not on a do not call list, are female, have a household income over fifty thousand dollars, and enjoy water sports. As another example, the user may execute a search for targets that have indicated a preference to receive email promotions. Once the search is submitted, sales and marketing campaign management system 100 will execute the search and generate a preference search results screen.

In one embodiment, the preference search results screen includes a preference message for each target to identify the preference data contained in preferences database 105 for that particular target. Preference messages indicate for example, whether it is okay to call, email, or send a facsimile. Similarly, if it is not okay to contact the target, the preference message indicates the reasons why. In accordance with an embodiment of the present invention, the preference message may also include the demographic information identified by the flags associated with the target in preferences database 105. By providing such preference messages, the present invention provides the user with the ability to quickly identify target contacts that can and cannot be contacted. Using the available demographic information, the present invention further provides the user with the ability to target advertising and marketing activities to prospective consumers mostly likely to be interested in the products or services being offered.

6.0 Monitoring and Reporting Functions

As previously mentioned, there can be severe consequences for failing to abide by consumer preferences. For example, contacting a prospective consumer whose target contact information appears on the Federal Trade Commission's DO NOT CALL list can result in a fine in excess of $11,000 dollars. Similarly, contacting an existing customer whose target contact information appears on the company's internal do-not-call or -contact list can also result in a fine in excess of $11,000. It can also cause the company to lose that customer. Therefore, there is a significant need to ensure that sales and marketing representatives are checking for such preferences before initiating contact with an existing customer or prospective consumer. However, monitoring can be difficult since such representatives are often located in geographically dispersed locations. In some cases, an existing customer or prospective consumer may complain that they were contacted despite having their target contact information registered on a preference list, such as the FTC's DO NOT CALL LIST. These complaints may form the basis of investigations by state attorneys general and the Federal government, as well as class-action lawsuits. In such cases, it will be necessary to investigate the circumstances associated with the contact. For example, a company will want to know when it received the preference data. The company may also want to know if a preference query was initiated prior to contacting the existing or prospective consumer. For this reason, in an embodiment of the present invention, sales and marketing campaign management system 100 maintains archive data corresponding to when preference data was added to or deleted from preferences database 105. Archive data may also indicate who has initiated a preference search, when the preference search was initiated, and the target contact information provided. In this way, a company can track the level of use of the system by its sales and marketing representatives and investigate consumer complaints as necessary.

While various embodiments of the present invention have been described above, it should be understood that they have been presented by way of example only and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

We claim:

1. A system for determining targets to contact in a sales or marketing campaign, comprising:
a storage device that stores a consumer preference table containing one or more entries indicating a consumer identifier and one or more consumer preferences;
a campaign management module containing a controller, operably in communications with the storage device, the controller for searching the consumer preference table entries for matches to one or more prospective consumer target identifiers contained in a prospective consumer target list.

2. The system of claim 1 further comprising a user interface device for allowing a user to enter the prospective consumer target identifiers.

3. The system of claim 1 wherein the entries indicating a consumer identifier in the preference table consist of one of phone numbers, IP addresses, user machine codes, consumer names, and email addresses.

4. The system of claim 1 wherein the searching results contain do-not-contact information identifying prospective targets for whom contact is prohibited.

5. The system of claim 4 wherein the do not contact information is associated with one or more phone numbers.

6. The system of claim 4 wherein the do not contact information is associated with one or more email addresses.

7. The system of claim 4 wherein the do not contact information consists of one of emails, phone numbers, IP addresses and machine codes.

8. The system of claim 1 further comprising a user interface for allowing users to enter the prospective consumer target identifiers.

9. The system of claim 8 wherein the consumer target identifiers contain telephone numbers.

10. The system of claim 8 wherein the consumer target identifiers contain email addresses.

11. The system of claim 8 wherein the consumer target identifiers consist of one of telephone numbers, email addresses, IP addresses and machine codes.

12. The system of claim 8 further comprising a user device consisting of one of a personal computer, wired device, wireless device, mobile device, cell phone, personal data assistant, and electronic tablets; and
wherein the user interface is a component of the user device.

13. The system of claim 1 wherein the campaign management module contoller searches the preference table by table lookup.

14. A computer readable medium for use as part of a sales and marketing campaign containing a data structure with consumer preference data comprising:
a preference table containing one or more entries indicating consumer identifiers; and
for each entry, associating a time stamp and one or more consumer preference list flags.

15. The computer readable medium of claim 14 wherein the flags indicate whether the consumer appears on one or more do not contact lists.

16. The computer readable medium of claim 14 wherein the consumer identifier entries contain phone numbers.

17. The computer readable medium of claim 14 wherein the consumer identifier entries contain email addresses.

18. A method for determining targets to contact in a sales or marketing campaign, comprising:
receiving a prospective consumer target list, the list containing one or more prospective consumer target identifiers;
accessing a consumer preference table containing one or more entries indicating a consumer identifier and one or more consumer preferences; and
searching the consumer preference table entries for matches to the prospective consumer target identifiers contained in the prospective consumer target list.

19. The method of claim 18 wherein the consumer identifier entries in the preference table consist of one of phone numbers, IP addresses, user machine codes, consumer names and email addresses.

20. The method of claim 18 further comprising creating a resultant target list, the list containing do-not-contact information identifying impermissible prospective consumers to target.

21. The method of claim 20 wherein the do not contact information is associated with one or more phone numbers.

22. The method of claim 20 wherein the do not contact information is associated with one ore more email addresses.

23. The method of claim 20 wherein the do not contact information includes codes identifying one or more do not contact lists that the impermissible prospective consumers appears on.

24. The method of claim 18 wherein the preference table further comprises a time stamp and one or more preference list flags associated with each consumer preference table identifier entry.

25. The method of claim 18 further comprising entering the prospective consumer target identifiers.

26. A system for determining targets to contact in a sales or marketing campaign, comprising:
a means for receiving one or more prospective consumer target identifiers;
a means for storing a consumer preference table containing one or more entries indicating a consumer identifier and one or more consumer preferences; and
a means, operably in communications with the storing means, for searching the prospective consumer target identifiers with the consumer preference table entries to obtain a resultant target list.

27. A system for determining targets to contact in a sales or marketing campaign, comprising:
a storage device that stores a preference table containing one or more entries indicating a consumer identifier and one or more consumer preferences;
a user interface that allows a user to enter one or more prospective consumer target identifiers;
a display associated with the user interface; and
a campaign management module, operably in communications with the storage device, that searches the preference table entries for a consumer identifier that matches the one or more prospective consumer target identifiers.

28. The system of claim 27 wherein the consumer identifier consists of one of telephone numbers, facsimile numbers, IP addresses, user machine codes, consumer names, business names, and email addresses.

29. The system of claim 28 wherein the one or more consumer preferences identify a demographic associated with the consumer identifier.
